(19) United States
(12) Patent Application Publication
(10) Pub. No.: US 2004/0126654 A1
(43) Pub. Date: Jul. 1, 2004

(54) Electrochemical cell laminate for alkali metal polymer batteries and method for making same

(76) Inventors: Anthony Sudano, Laval (CA); Richard Laliberte, Ste-Julie (CA)

Correspondence Address: SMART & BIGGAR, Suite 3400, 1000 de la Gauchetiere Street West, Montreal, QC, H3B 4W5, CA

(21) Appl. No.: 10/329,363

(22) Filed: Dec. 27, 2002

(51) Int. Cl. H01M 6/12; H01M 2/14; H01M 4/66; H01M 6/46

(52) U.S. Cl. 429/162; 429/233; 429/130; 429/245; 429/152; 429/234; 29/623.1

(57) ABSTRACT

An electrochemical cell laminate is disclosed which comprises an electrolyte separator, a cathode film and a cathode current collector, a metallic anode film, and an insulating support film onto which the cathode film and the cathode current collector are coated onto a first surface thereof and the metallic anode film is positioned onto a second surface thereof. The cathode film and the anode film being electrically and ionically isolated from each other by the insulating support film. The electrochemical cell laminate according to the invention may be stacked wound or rolled to form an electrochemical battery.

### FIELD OF THE INVENTION

The present invention generally relates to alkali metal polymer batteries and, more specifically, to electrochemical cell (EC) laminates for alkali metal polymer batteries.

### BACKGROUND OF THE INVENTION

Rechargeable batteries manufactured from laminates of solid polymer electrolytes and sheet-like electrodes display many advantages over conventional liquid electrolytes batteries. These advantages include: lower overall battery weight; high power density; high specific energy; and longer service life.

Solid polymer cell components generally include positive electrodes (also referred to as cathodes), negative electrodes (also referred to as anodes), and a separator material capable of permitting ionic conductivity sandwiched between each anode and cathode. Moreover, a current collector can be associated with each electrode, especially the cathodes.

Typical electrochemical generators comprise a plurality of individual electrochemical cell laminates stacked or bunched together to form a battery. Individual electrochemical cell laminates are typically mono-face or bi-face configurations. A mono-face electrochemical cell, as shown in FIG. 1, is a laminate including a current collector, a cathode, an electrolyte separator, and an anode covered with an insulating polypropylene film to insulate the electrochemical cell from the next one to prevent short circuits.

A bi-face electrochemical cell, as shown in FIG. 2, is a laminate including a central current collector having a cathode layer on both sides, an electrolyte separator adjacent each cathode layer, and an anode layer adjacent each electrolyte separator as illustrated in FIG. 2. In a bi-face cell configuration, the insulating polypropylene film is eliminated since the risk of short-circuits between the anode and the cathode of adjacent cells is removed.

There are drawbacks to the above basic electrochemical cell laminate configurations. First, the insulating film layer of the mono-face laminate, and to a lesser extent the current collector, are considered passive components because they do not participate in the energy generating process. This therefore can represent a substantial weight and volume penalty. Secondly, as soon as an electrochemical cell laminate of either configuration is assembled, it is “live”, and must be handled with great care. That is why electrochemical cells are usually assembled as half-cells until final assembly. This hinders the flexibility of the manufacturing process.

Thus there is a need in the industry for electrochemical cell laminates which are relatively lighter and thinner than prior art cell configurations, and which provide more flexibility in the manufacturing process.

### SUMMARY OF THE INVENTION

Under a first broad aspect, the invention seeks to provide an electrochemical laminate comprising: a first electrode layer; a second electrode layer; and an electrolyte. The first and second electrode layers and the electrolyte are arranged side-by-side. The first electrode layer is ionically isolated from the second electrode layer.

Advantageously, the electrochemical laminate further comprises a current collecting layer and an insulating film layer which are also arranged in a side-by-side relationship. Preferably, the current collecting layer has a multi-layer structure including a conductive metallic layer and a protective metallic layer. Moreover, one of the electrode layers is an anode layer and the other of the electrode layers is a cathode layer.

Under a second broad aspect, the invention further seeks to provide an electrochemical laminate comprising: a first electrode layer; a second electrode layer; and an electrolyte. The first and second electrode layers and the electrolyte are arranged side-by-side. The electrochemical laminate is free of an ionic path from the first and second electrode layers through the electrolyte layer.

Under a third broad aspect, the invention also seeks to provide an electrochemical generator comprising first and second electrochemical laminates. Each electrochemical laminate includes: a first electrode layer; a second electrode layer; and an electrolyte layer. The first and second electrode layers and the electrolyte layer are arranged side-by-side. The first and second electrochemical cell laminates are disposed in a stack and an ionic path is established therebetween.

Under a fourth broad aspect, the invention also seeks to provide a method for producing an electrochemical generator. The method comprises: providing first and second electrochemical laminates; assembling them in a stack; and establishing an ionic path therebetween. Each electrochemical laminate includes: a first electrode layer; a second electrode layer; and an electrolyte layer. The first and second electrode layers and the electrolyte layer are arranged side-by-side.

Under a fifth broad aspect, the invention also seeks to provide an electrochemical cell laminate comprising: An electrochemical cell laminate comprising;

an electrolyte separator;

a cathode layer; and

an insulating support film having a first surface and a second surface, a conductive metal layer deposited on said first surface; said conductive metal layer serving as a current collector for said composite cathode layer, and a metallic anode film vacuum deposited on said second surface; wherein said current collector is completely insulated from said metallic anode film by said insulating support film.

Under a sixth broad aspect, the invention also seeks to provide an electrochemical cell laminate, comprising:

an electrolyte separator;

a cathode film and a cathode current collector;

a metallic anode film; and

an insulating support film having a first surface and a second surface, wherein said cathode film and said cathode current collector are coated on said first surface and said metallic anode film is positioned over said second surface; said cathode film and said anode film being electrically and ionically isolated from each other by said insulating support film;

wherein said electrochemical cell laminate remains electrochemically inactive until assembled into a generator.

### BRIEF DESCRIPTION OF THE DRAWINGS

A detailed description of preferred embodiments of the present invention is provided herein below with reference to the following drawings, in which:

FIG. 1 is a schematic cross-sectional view of a mono-face electrochemical cell laminate in accordance with the prior art;

FIG. 2 is a schematic cross-sectional view of a bi-face electrochemical cell laminate in accordance with the prior art;

FIG. 3 is a schematic cross-sectional view of an electrochemical cell laminate according to a first embodiment of the invention;

FIG. 4 is a schematic cross-sectional view of a series of electrochemical cell laminates as shown in FIG. 3 stacked together to form an electrochemical generator;

FIG. 5 is a schematic cross-sectional view of an electrochemical cell laminate according to a second embodiment of the invention;

FIG. 6 is a schematic cross-sectional view of a series of electrochemical cell laminates as shown in FIG. 5 stacked together to form an electrochemical generator;

FIG. 7a is a schematic perspective view of an electrochemical cell packaged as a flat roll configuration to form a generally flat wounded structure;

FIG. 7b is a cross sectional view taken at line 7b-7b of FIG. 7a;

FIG. 8a is a schematic perspective view of an electrochemical cell packaged as a ‘jelly roll’ to form a generally cylindrical structure; and

FIG. 8b is a cross sectional view taken along line 8b-8b of FIG. 8a.

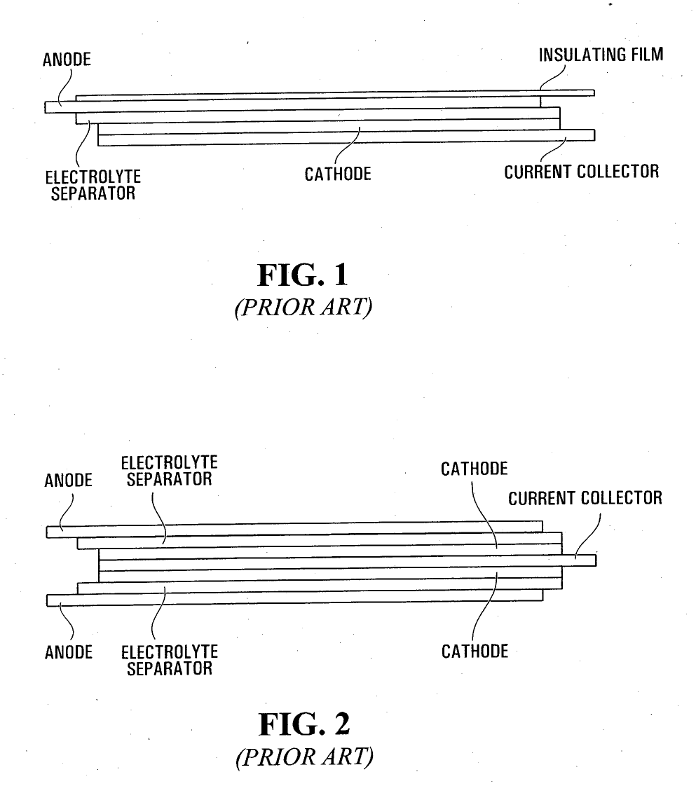

In the drawings, preferred embodiments of the invention are illustrated by way of examples. It is to be expressly understood that the description and the drawings are only for the purpose of illustration and as an aid to understanding. They are not intended to be a definition of the limits of the invention.

### DETAILED DESCRIPTION

As previously mentioned, current collectors in electrochemical (EC) cells are passive components that transport the currents generated by the chemical reaction between the anode and the cathode. Current collectors also act as mechanical supports for paste-like anodes or cathodes and, as such, should be as strong but as thin as practicable to reduce the weight and volumetric penalty of the current collector to the overall weight and volume of the electrochemical generator; the latter comprising a plurality of electrochemical cell laminates.

A current collector in accordance with an embodiment of the present invention comprises an insulating polymer support film, which is generally made of synthetic resin and which generally has a thickness of between about 4 and 15 microns, and preferably between about 4 to 10 microns, onto which is deposited by vacuum vapor metallization a conductive metallic layer generally having a thickness of between about 0.1 and 3 microns, and preferably between about 0.3 to 1 micron. The conductive metallic layer is preferably an aluminum or copper layer which is thereafter protected against corrosion by a protective layer that is adapted to shield the conductive metallic layer against the corrosive effect of the cathode, the anode or the electrolyte materials. The protective layer is preferably a 10-100 nm thick silver, platinum, palladium, or a metal oxide layer deposited onto the conductive metallic layer by vacuum metal sputtering. Although the conductive metallic layer and the protective layer are respectively formed by vacuum vapor metallization and vacuum metal sputtering, both of which are well known in the art, alternative methods can be used for forming these layers.

In a preferred configuration of an electrochemical cell laminate according to the present invention, only one surface of the insulating polymer support film is coated by vacuum vapor metallization with a conductive metallic layer. The side of the insulating polymer support film which has been coated will serve as a current collector for the cathode of the electrochemical cell. The opposite surface of the insulating polymer support film is also coated with a metallized anode layer, preferably of lithium or lithium alloy. Such coating can also be achieved by vacuum vapor metallization deposition. This side of the insulating polymer support film will serve as the anode of the electrochemical cell.

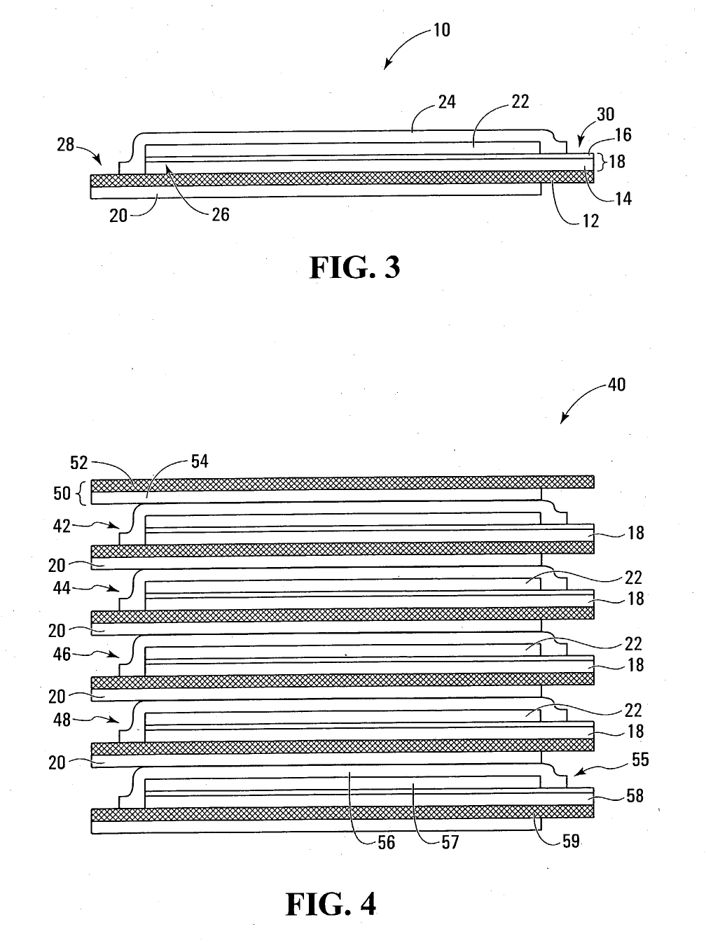

With reference to FIG. 3, there is shown a preferred embodiment of an individual electrochemical cell laminate according to the invention. The electrochemical cell laminate 10 comprises a centralized insulating polymer support film 12 of about 5-15 μm thick, a conductive metallic layer 14 of about 0.3-2 μm thick, and a protective layer 16 of about 10-50 nm thick which acts to inhibit corrosion. The conductive metallic layer 14 preferably includes aluminum or copper while the protective layer 16 preferably includes silver, or a metal oxide which is compatible with the cathode material. The protective layer 16 is preferably deposited onto the conductive metallic layer 14 by metal sputtering. The conductive metallic layer 14 and the protective layer 16 serve as a current collector 18 for the cathode. The other side of the insulating polymer support film 12 is coated with an anode film 20. In this example of implementation, the anode film, which preferably comprises lithium or a lithium alloy and is about 1-15 μm thick, is also deposited by vacuum metal vapor deposition; the anode film 20 being electrically and chemically isolated from the conductive metallic layer 14 by the insulating polymer support film 12. A composite cathode layer 22 about 30-80 μm thick, in this embodiment a mixture of active material such as transitional metal oxide, an electronically conductive filler such as carbon black and/or graphite and an ionically conductive polymer or polyimide binder material, is positioned directly onto the protective layer 16 of current collector 18 and a polymer or polyimide electrolyte separator 24 about 10-30 μm covers the entire cathode layer 22 and one end 26 of current collector 18. As illustrated in FIG. 3, the anode film 20 is offset relative to the cathode layer 22 and its current collector 18 so as to expose it along a first edge 28 of the electrochemical cell laminate 10 and to expose the cathode current collector 18 along a second edge 30 of the electrochemical cell laminate 10. This also helps prevent contacts between the anode film and cathode layer when they are assembled into stacks. In order to offset the anode film 20 and the current collector 18 relative to one another, the first edge 28 of the insulating polymer support film 12 is masked when layers 14 and 16 of the current collector 18 are successively deposited by vacuum metal vapor deposition onto a first side of the insulating polymer support film 12, and the second edge 30 of the insulating polymer support film 12 is masked when the anode film 20 is deposited by vacuum metal vapor deposition onto the other side of the polymer support film 12 in a subsequent deposition step.

Electrochemical cell laminate 10 comprises all the necessary components to produce electricity but is inactive because the anode and the cathode are completely isolated from each other and ion exchange is impossible. Electrochemical cell laminate 10 may therefore be handled without danger and can safely be transported.

FIG. 4 illustrates a series of electrochemical cell laminates 10 stacked together to form a electrochemical generator 40. Once assembled together the anode film 20 of a first cell laminate 42 may react electrochemically with the cathode 22 of the second cell laminate 44. Similarly, the anode film 20 of the second cell laminate 44 may react electrochemically with the cathode 22 of the third cell laminate 46 and so on. The anode film 20 of the cell laminate 46 may react electrochemically with the cathode 22 of the cell laminate 48. The stacking arrangement shown in FIG. 4 is only an illustration and comprises four electrochemical cell laminates 10. However, any number of electrochemical cell laminates may be used.

As illustrated, the first cell laminate 42 is completed with a hybrid anode 50 preferably including a polymer insulating film 52 about 5-15 μm thick onto which a metallic lithium or lithium alloy film 54 of about 1-15 μm thick is also deposited by vacuum metal vapor deposition such that the cathode 22 of a first cell laminate 42 may react electrochemically with the hybrid anode film 50 such that the cathode 22 of cell laminate 42 is an active component of the stack electrochemical generator 40. Similarly, the anode 20 of last cell laminate 48 is juxtaposed to a hybrid half-cell 55 consisting of a polymer or polyimide electrolyte separator 56, a cathode layer 57, a cathode current collector 58 identical to current collector 18 and a polymer insulating film 59 supporting the current collector 58, the cathode layer 57 and the electrolyte separator 56. Anode 20 of cell laminate 48 may then react electrochemically with cathode 57 of half-cell 55 such that the anode film of cell laminate 48 is an active component of the stack electrochemical generator 40.

Once the stack is completed, all cathode current collectors 18 and current collector 58 extending from one edge of the stack are connected together as is well known in the art. Similarly, all lithium metal anode films extending from the other edge of the stack are also connected together as is well known in the art to form a laminate stack electrochemical generator connected in parallel.

There are many advantages to the configuration of the electrochemical cell laminate 10. First, there is a substantial reduction of the volume and weight of insulating films typically used in a mono-face electrochemical cell laminate stack since the insulation is performed by the insulating support film 12; one of the main functions of which being to support the metallized anode and cathode current collector. Second, there is a substantial reduction of the volume and weight of the cathode current collector as well as a reduction of the volume and weight of the metallic anode film through the use of a vapor metallization technique. Finally, prior to assembling a series of electrochemical cell laminate 10, the cell laminate 10 is inactive since the anode and the cathode are isolated from one another. As such the electrochemical cell laminate 10 is complete yet safe to handle and transport; a substantial advantage in a manufacturing process comprising a plurality of steps.

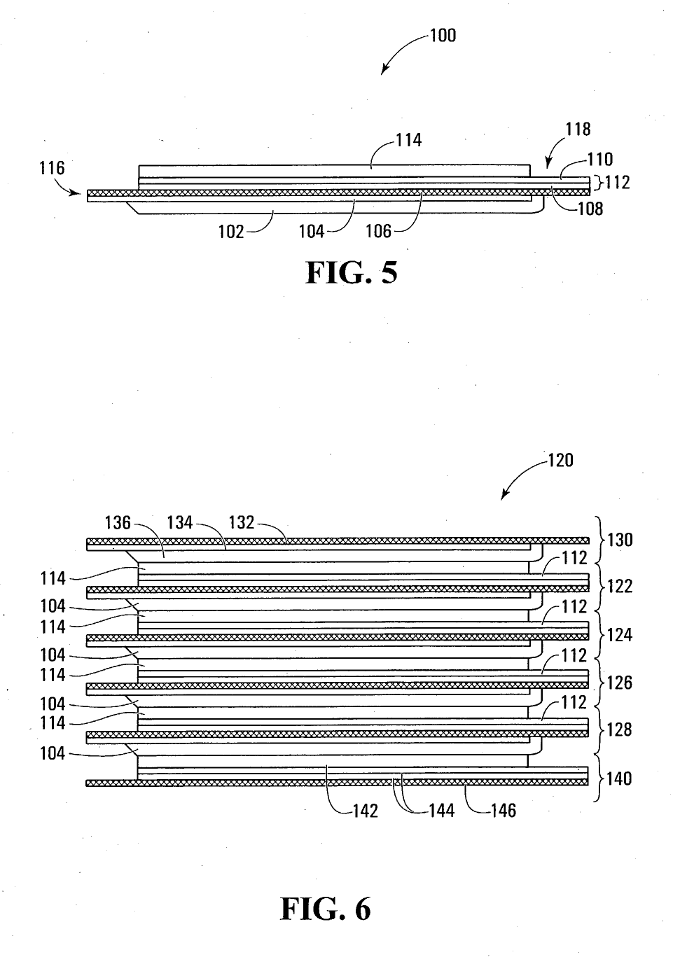

FIG. 5 illustrates a second embodiment of an individual electrochemical cell laminate 100 according to the invention. In this embodiment, the layer of polymer or polyimide electrolyte separator 102 covers a substantial portion of the anode film 104 as opposed to the cathode layer of electrochemical cell laminate 10 shown in FIG. 3.

The electrochemical cell laminate 100 also comprises a centralized insulating polymer support film 106 of about 5-15 μm thick, a conductive metallic layer 108 of about 0.3-2 μm thick covered with a corrosion protective layer 110 about 10-100 nm thick, successively deposited onto a first side of the insulating polymer support film 106 by vacuum vapor metallization. The conductive metallic layer 108, which preferably comprises aluminum or copper, and the protective layer 110 serve as current collector 112 for a composite cathode layer 114 consisting of a mixture of active material such as transitional metal oxide, an electrically conductive filler such as carbon black and/or graphite and an ionically conductive polymer or polyimide binder material. The anode film layer 104, which preferably comprises lithium or lithium alloy of about 5-15 μm thick, is also deposited by vacuum metal evaporation deposition. The insulating polymer support film 106 electrically and chemically isolates the cathode film 114 from the anode film 104. A polymer or polyimide electrolyte separator is layered over the anode film 104 leaving an edge 116 uncovered or exposed for electrical contact. As well, the edge 118 of the current collector 112 is left uncovered by the cathode film 114 for electrical contact. Again, the anode film 104 is offset relative to the cathode film 114 and its current collector 112 to prevent contact between the anode and cathode when assembled into stacks. In this state, electrochemical cell laminate 100 comprises all the necessary components to produce electricity however is inactive because the anode and the cathode are completely isolated from each other and ion exchange is impossible. Electrochemical cell laminate 100 may therefore be handled without danger and can be safely transported. Also, the weight and volume of the passive components of the electrochemical cell laminate i.e. the current collector and insulating film, and of the weight and volume of the anode film are substantially reduced.

FIG. 6 illustrates a series of electrochemical cell laminates 100 stacked together to form an electrochemical generator 120. Once assembled together the anode film 104 of the first cell laminate 122 may react electrochemically with the cathode 114 of the second cell laminate 124. Similarly, the anode film 104 of the second cell laminate 124 may react electrochemically with the cathode 114 of the third cell laminate 126 and so on. Each anode 104 and cathode 114 being separated by the ionically conductive polymer or polyimide separator 102 of each cell laminate 100. Again the stacking arrangement shown in FIG. 6 is only an illustration and comprises only four electrochemical cell laminates 100 however typical parallel cell stacking may comprise any number of electrochemical cell laminates.

As illustrated, the cathode 114 of the first cell laminate 122 is coupled to a hybrid half-cell 130 consisting of a polymer insulating film 132 about 5-15 μm thick onto which an anode film 134 of about 5-15 μm thick is deposited by vacuum vapor metallization and a polymer polyimide electrolyte separator layer 136 to complete the cell stack 120. The cathode 114 of the first cell laminate 122 may react electrochemically with the anode film 134 of the hybrid half-cell 130 such that the cathode 114 of the first cell laminate 122 is an active component of the stacked electrochemical generator 120 and not left unused. Similarly, at the other end of the cell stack 120, the anode 104 of the last cell laminate 128 is juxtaposed to a second hybrid half-cell 140 consisting of a cathode layer 142, a cathode current collector 144 and a polymer insulating film 146 supporting the current collector 144 and the cathode layer 142. The anode 104 of the last cell laminate 128 may then react electrochemically with cathode 142 of hybrid half-cell 140 such that the anode film of cell laminate 128 is an active component of the stacked electrochemical generator 120.

Once the stack is completed, all cathode current collectors 112 and current collector 144 extending from one edge of the stack are connected together as is well known in the art and all anode films 104 and 134 extending from the other edge of the stack are also connected together as is well known in the art to form a laminate stack electrochemical generator connected in parallel.

The advantages of the configuration of electrochemical cell 100 are identical to those of electrochemical cell 10 i.e. substantial reduction of the volume and weight of insulating films, cathode current collectors, anode films, and ease of handling and transport of the cell laminate prior to assembly into a stack electrochemical generator 120.

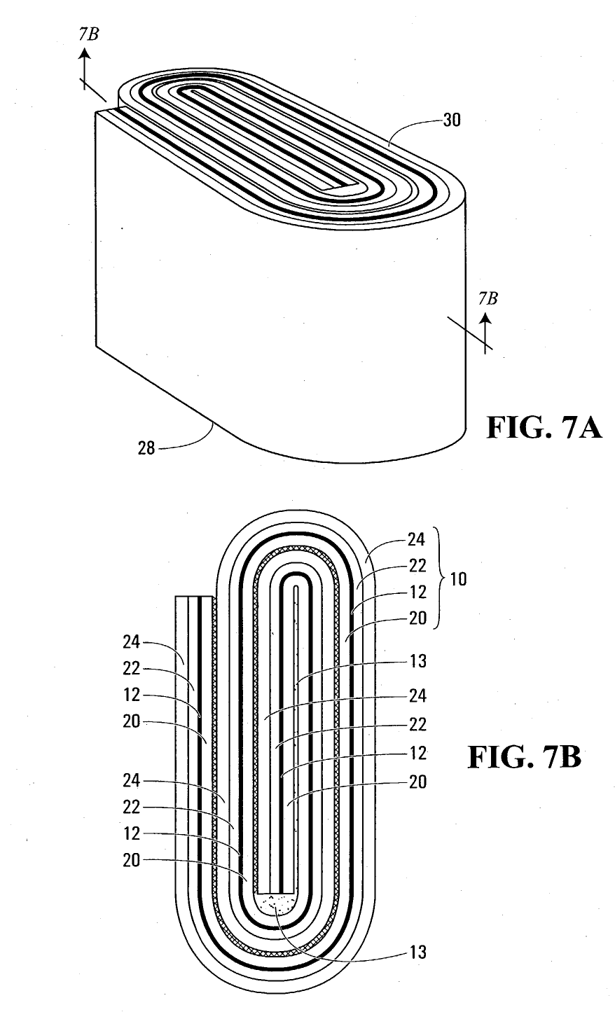

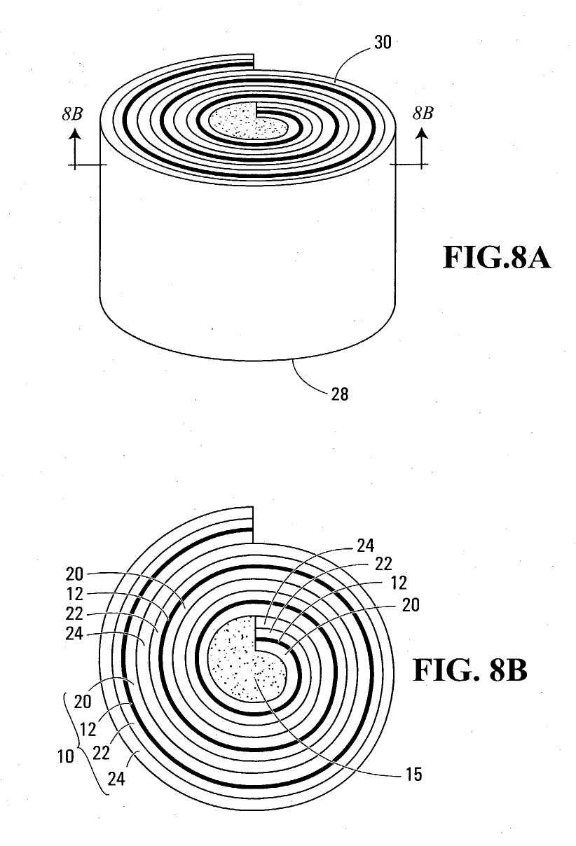

Any of the electrochemical cell laminates described above may be packaged in other configurations such as ‘jelly roll’ to form a generally cylindrical cell structure as illustrated in FIG. 8a or a flat roll configuration to form a generally flat wounded structure as illustrated in FIG. 7a. In both configurations, the flat cell laminate is rolled or wounded about itself. Rolling the flat cell laminate according to any one of the previously described laminates will juxtapose the anode side of the cell laminate to its cathode side sandwiching the electrolyte separator in between to form a live electrochemical cell. In the rolled up configurations, the cathode current collector extends from a first edge to form the positive contact while the anode or anode current collector extends from a second edge to form the negative contact. The positive and negative contacts are formed by any method known in the art such a metal spraying techniques.

FIGS. 7a and 7b illustrate an electrochemical cell laminate 10 as shown in FIG. 3 wounded in a flat roll configuration. As illustrated in FIG. 7b which is a cross sectional view taken at line 7b-7b of FIG. 7a, an electrochemical cell laminate 10 comprising an anode film 20, an insulating support film 12, a cathode film 22 and an electrolyte separator film 24 is wound such that the second layer will juxtapose the anode film 20 of the cell laminate 10 to its electrolyte separator film 24 and its cathode layer 22 thereby forming an active electrochemical cell generator. Please note that for ease of illustration, current collector 18 is incorporated into the cathode layer 22. To ensure that there are no short-circuit by direct contact of the anode film 20 and the cathode film 22, the end portion 13 of the laminate 10 should be isolated by any suitable means. In this configuration, the cathode current collector 18 extends from a first edge 30 to form the positive contact of the generator while the metallic anode film 20 extends from a second edge 28 to form the negative contact of the generator. The positive and negative contacts are formed by any method known in the art such a metal spraying techniques.

FIGS. 8a and 8b illustrate an electrochemical cell laminate 10 as shown in FIG. 3 wounded in a jelly roll configuration. As illustrated in FIG. 8b which is a cross sectional view taken at line 8b-8b of FIG. 8a, an electrochemical cell laminate 10 as defined above is wound such that the second layer will juxtapose the anode film 20 of the cell laminate 10 to its electrolyte separator film 24 and its cathode layer 22 thereby forming an active electrochemical cell generator. Again please note that for ease of illustration, current collector 18 is incorporated into the cathode layer 22. To ensure that there are no short-circuit by direct contact of the anode film 20 and the cathode film 22, the end portion 15 of the laminate 10 should be isolated by any suitable means. In this configuration, the cathode current collector 18 extends from a first edge 30 to form the positive contact of the generator while the metallic anode film 20 extends from a second edge 28 to form the negative contact of the generator. The positive and negative contacts are formed by any method known in the art such a metal spraying techniques.

The thickness of the various components of the electrochemical cell laminate according to the invention varies according to end use and should not be interpreted as limiting the scope of the present invention. However for a similar end use application, an electrochemical cell laminate according to the invention will be thinner than a prior art electrochemical cell laminate.

Although the present invention has been described in relation to particular variations thereof, other variation and modifications are contemplated and are within the scope of the present invention. Therefore the present invention is not to be limited by the above description but is defined by the appended claims.

What is claimed is:

1. An electrochemical laminate, comprising:
a first electrode layer;
a second electrode layer;
an electrolyte layer, said first electrode layer, said second electrode layer and said electrolyte layer being arranged side-by-side;
said first electrode layer being ionically isolated from said second electrode layer.

2. An electrochemical laminate as defined in claim 1, further comprising a current collector layer, said current collector layer being arranged in a side-by-side relationship with one of said first and second electrode layers.

3. An electrochemical laminate as defined in claim 2, further comprising an insulating film layer, said insulating film layer being arranged in a side-by-side relationship with said current collector layer, said insulating film layer being located between said first and second electrode layers.

4. An electrochemical laminate as defined in claim 2, wherein said current collector layer has a multi-layer structure including:
a conductive metallic layer; and
a protective metallic layer.

5. An electrochemical laminate as defined in claim 3, wherein one of said electrode layers is an anode layer and the other of said electrode layers is a cathode layer.

6. An electrochemical laminate as defined in claim 4, wherein said conductive metallic layer comprises a metal selected from the set consisting of aluminum and copper.

7. An electrochemical laminate as defined in claim 6, wherein said protective metallic layer comprises a metal selected from the set consisting of silver, platinum, palladium, and metal oxides.

8. An electrochemical laminate as defined in claim 5, wherein said anode layer comprises lithium or a lithium alloy.

9. An electrochemical laminate as defined in claim 5, wherein said anode layer is offset relative to said cathode layer and said current collector layer.

10. An electrochemical laminate as defined in claim 9, wherein said anode layer is exposed along a first edge of the electrochemical laminate and said current collector layer is exposed along a second edge of the electrochemical laminate.

11. An electrochemical laminate, comprising:
a first electrode layer;
a second electrode layer;
an electrolyte layer, said first electrode layer, said second electrode layer and said electrolyte layer being arranged side-by-side;
said electrochemical laminate being free of an ionic path from said first electrode layer and said second electrode layer through said electrolyte layer.

12. An electrochemical laminate as defined in claim 11, further comprising a current collector layer, said current collector layer being arranged in a side-by-side relationship with one of said first and second electrode layers.

13. An electrochemical laminate as defined in claim 12, further comprising an insulating film layer, said insulating film layer being arranged in a side-by-side relationship with said current collector layer, said insulating film layer also being located between said first and second electrode layers.

14. An electrochemical laminate as defined in claim 12, wherein said current collector layer has a multi-layer structure including:
a conductive metallic layer; and
a protective metallic layer.

15. An electrochemical laminate as defined in claim 13, wherein one of electrode layers is an anode layer and the other of said electrode layers is a cathode layer.

16. An electrochemical laminate as defined in claim 14, wherein said conductive metallic layer comprises a metal selected from the set consisting of aluminum and copper.

17. An electrochemical laminate as defined in claim 16, wherein said protective metallic layer comprises a metal selected from the set consisting of silver, platinum, palladium, and metal oxides.

18. An electrochemical laminate as defined in claim 15, wherein said anode layer comprises lithium or a lithium alloy.

19. An electrochemical cell laminate as defined in claim 15, wherein said anode layer is offset relative to said cathode layer and said current collector layer.

20. An electrochemical cell laminate as defined in claim 19, wherein said anode layer is exposed along a first edge of the electrochemical laminate and said current collector layer is exposed along a second edge of the electrochemical laminate.

21. An electrochemical generator, comprising:
a first electrochemical laminate, including:
a) a first electrode layer;
b) a second electrode layer;
c) an electrolyte layer, said first electrode layer, said second electrode layer and said electrolyte layer being arranged side-by-side;
a second electrochemical laminate, including:
a) a first electrode layer;
b) a second electrode layer;
c) an electrolyte layer, said first electrode layer, said second electrode layer and said electrolyte layer being arranged side-by-side;
said first and second electrochemical laminates being disposed in a stack and establishing an ionic path between said first electrochemical laminate and said second electrochemical laminate.

22. An electrochemical generator as defined in claim 21, wherein one of said first and second electrode layers of said first electrochemical laminate is an anode layer and the other of said first and second electrode layers of said first electrochemical laminate is a cathode layer.

23. An electrochemical generator as defined in claim 22, wherein one of said first and second electrode layers of said second electrochemical laminate is an anode layer and the other of said first and second electrode layers of said second electrochemical laminate is a cathode layer.

24. An electrochemical generator as defined in claim 23, wherein said ionic path is established between the anode layer of one of said first and second electrochemical laminates and the cathode layer of the other of said first and second electrochemical laminates.

25. A method for producing an electrochemical generator, comprising:
providing a first electrochemical laminate, including:
a) a first electrode layer
b) a second electrode layer;
c) an electrolyte layer, said first electrode layer, said second electrode layer and said electrolyte layer being arranged side-by-side;
providing a second electrochemical laminate, including:
a) a first electrode layer;
b) a second electrode layer;
c) an electrolyte layer, the first electrode layer of said second electrochemical laminate, the second electrode layer of said second electrochemical laminate and the electrolyte layer of said second electrochemical laminate being arranged side-by-side;
assembling said first electrochemical laminate and said-second electrochemical laminate in a stack and establishing an ionic path therebetween.

26. An electrochemical cell laminate, comprising;
an electrolyte separator;
a composite cathode layer; and
an insulating support film having a first surface and a second surface, a conductive metal layer deposited on said first surface; said conductive metal layer serving as a current collector for said composite cathode layer, and a metallic anode film vacuum deposited on said second surface; wherein said current collector is completely insulated from said metallic anode film by said insulating support film.

27. An electrochemical cell laminate, comprising:
an electrolyte separator;
a cathode film and a cathode current collector;
a metallic anode film; and
an insulating support film having a first surface and a second surface, wherein said cathode film and said cathode current collector are coated on said first surface and said metallic anode film is positioned over said second surface; said cathode film and said anode film being electrically and ionically isolated from each other by said insulating support film;
wherein said electrochemical cell laminate remains electrochemically inactive until assembled into a generator.
